(19) United States
(12) Patent Application Publication
(10) Pub. No.: US 2016/0017913 A1
(43) Pub. Date: Jan. 21, 2016

(54) SELECTIVELY ORIENTABLE STATIC BEARING ASSEMBLY

(71) Applicant: Spyraflo, Inc., Peachtree City, GA (US)

(72) Inventors: Alan Guthrie, Sharpsburg, GA (US); Jessica Reynolds, La Grange, GA (US)

(21) Appl. No.: 14/800,388

(22) Filed: Jul. 15, 2015

Related U.S. Application Data
(60) Provisional application No. 62/025,267, filed on Jul. 16, 2014.
(60) Provisional application No. 62/130,234, filed on Mar. 9, 2015.

(51) Int. Cl. F16C 11/06

(52) U.S. Cl. CPC F16C 11/06; F16C 11/0685

(57) ABSTRACT

A selectively orientable static bearing assembly is provided for allowing objects attached thereto to be pivoted and rotated to a predetermined orientation and then released. When released, the object is held by the bearing assembly in the new orientation without the need for locking screws or other separate locking mechanisms.

### REFERENCE TO RELATED APPLICATIONS

Priority is hereby claimed to the filing date of U.S. provisional patent application 62/025,267 filed on Jul. 16, 2014 and to the filing date of U.S. provisional patent application 62/130,234 filed on Mar. 9, 2015, the disclosures of which are hereby incorporated by reference.

### TECHNICAL FIELD

This invention relates generally to static bearings for supporting objects and more specifically to static bearings that facilitate selective orientation of a supported object with the bearing maintaining the orientation of the object thereafter.

### BACKGROUND

Self-aligning ball bearings and bushings are commonly used in smaller appliances such as printers and copiers and sometimes in larger applications to support rotating shafts. Our prior U.S. Pat. Nos. 8,727,630; 6,238,096; and 5,911,515 are directed to such bearings having various unique characteristics. The disclosures of these patents are hereby incorporated by reference in their entireties.

Another type of bearing referred to herein as a “static” bearing is a bearing that does not necessarily accommodate rotating motion of a shaft as in the above patents, but rather supports and positions objects attached to the bearings. The scope of such objects may be wide indeed and may include, just for instance, flashlights, lighting sensors, indicators, microphones, cameras, video displays, tools, control panels, and human interface devices. Thus, whenever the terms “object” or “objects” are used herein, they are intended to include any and all items that may be appropriately supported and oriented by a static bearing.

Static bearings of the prior art that allow selective orientation of objects mounted thereto traditionally require that some part of the bearing be loosened to allow an object to be oriented and retightened to secure the object in a selected orientation. The ball head of a camera tripod is an example wherein the mounting plate to which a camera is attached is secured to a swivel ball captured within a socket. To move the camera, a release is rotated, which loosens the socket around the swivel ball allowing the ball to move within the socket. In this state, the camera can be oriented as desired, after which the release is tightened to lock the swivel ball within its socket and thereby lock the camera in a desired orientation. This and other similar processes of the past generally require the tightening of screws, levers, or knobs to secure a supported object in a selected orientation.

While prior art static bearings work fairly well when the bearing is large, exposed, and its locking mechanisms accessible, it can be another story entirely in situations where a static bearing is small, hidden, obscured, or otherwise inaccessible. In such situations, locking mechanisms such as screws or releases can be difficult or impossible to manipulate and the process of orienting an object attached to the bearing can be frustrating at best. When objects and their static bearings are very small, such as objects mounted inside a machine or device, multi-step orienting and tightening procedures simply are not feasible. Even where the bearing may be accessible, the process of loosening, orienting, and retightening can be cumbersome and annoying. For example, for sports and action video cameras mounted to the helmet of a skier, skydiver, or other sports enthusiast, it can be extremely difficult or impossible for the wearer to adjust the orientation of the video camera if manipulation of a locking mechanism is required. In these and other application, it is virtually required that the wearer be able to adjust the orientation of the camera with one hand with the camera maintaining this orientation after adjustment.

A need therefore exists for a static bearing to which an object may be attached that does not require ancillary locking screws or other mechanisms to move an object attached to the bearing to a desired orientation and have it stay there after it is moved. It is to the provision of such a static bearing that the present disclosure is primarily directed.

### SUMMARY

Briefly described, the present invention, in one preferred embodiment thereof, is a selectively orientable static bearing assembly to which objects can be mounted. The static bearing assembly comprises a generally annular retainer having a central axis, an outside wall, and a generally conical inside wall that defines a bearing seat. A pivot bearing having a generally spheroidal outside wall is mounted within the retainer with its outside wall resting against the bearing seat defined by the inside wall of the retainer. The spheroidal outside wall of the pivot bearing has a diameter between a smallest diameter and a largest diameter of the generally conical inside wall of the retainer.

An elastomeric compression ring is mounted within the retainer on an end opposite the bearing seat and extends inwardly to bear against the spheroidal outside wall of the pivot bearing. The elastomeric compression ring is positioned and sized to apply a predetermined force to the pivot bearing to hold it firmly between the bearing seat and the compression ring. The elastomeric compression ring permits pivotal and rotational movement of the pivot bearing within the retainer when sufficient pivoting force is applied to overcome the internal friction between the pivot bearing and the retainer. This internal friction is predetermined by the size, shape, and composition of the compression ring.

The pivot bearing is provided with a mounting structure such as, for instance, a threaded opening in the pivot bearing or a projecting threaded stud extending from the pivot bearing to which an object can be securely mounted. When an object is firmly attached to the pivot bearing, the object can be moved to a desired pivotal orientation and/or rotational position simply by grasping the object and moving it to the desired orientation. The movement of the object in this way is facilitated by pivotal movement of the pivot bearing within the retainer against the friction of the compression ring. When the object is located in the desired orientation, it need only be released, whereupon the orienting force ceases. For a given application, the force provided by the compression ring is selected to hold the object in place after the orienting force is no longer present. So, the object, once oriented, remains in place when released. Neither locking screws nor other devices need be manipulated to lock the object in the desired orientation. It may be said that the pivot bearing provides manual positional articulation and orientation of the object while preventing movement of the object when the manually applied positioning force is removed. In one embodiment, the static bearing is provided with press-fit and self-clinching capabilities such that it can easily be mounted to a chassis, pillow block, frame, or other supporting structure.

The above features, aspects, and advantages will become more apparent upon review of the detailed description set forth below taken in conjunction with the accompanying drawing figures, which are briefly described as follows.

### BRIEF DESCRIPTION OF THE DRAWINGS

FIG. 1 is a perspective view showing a bearing according to one embodiment of the invention in two different pivotal orientations.

FIG. 2 is a perspective view showing the bearing of FIG. 1 in two orientations and viewed from a different angle.

FIG. 3 is a perspective view showing the bearing of FIG. 1 in two orientations and viewed from yet another slightly different angle.

FIG. 4 is a perspective view of the bearing of FIG. 1 in two orientations and with an attachment stud extending from the pivot bearing for mounting an object to the bearing.

FIG. 5 is a perspective view showing the bearing of FIG. 4 viewed from a different angle.

FIG. 6 is a cross section of the bearing illustrated in previous figures in one orientation and showing internal features thereof.

FIG. 7 is a cross section of the bearing illustrated in previous figures in another orientation and showing internal features thereof.

FIG. 8 is a perspective CAD drawing of the bearing of FIGS. 6 and 7 showing external details of the bearing.

FIG. 9 is a cross sectional view of another embodiment of a static bearing according to the present disclosure in one orientation.

FIG. 10 is a cross sectional view of the static bearing static bearing of FIG. 9 shown in another one orientation.

FIG. 11 is a figure taken from one of the incorporated patents and illustrates the press fit and self-clinching features that also can be a part of the static bearing of the present invention.

FIG. 12 is a perspective view of another embodiment of the static bearing having threaded bores in its base for mounting to a surface.

FIG. 13 is a cross sectional view of the static bearing of FIG. 12 illustrating internal placement of the threaded bores.

FIG. 14 is a perspective view from another angle of the static bearing of FIG. 12.

FIG. 15 is a cross sectional view of the static bearing of FIG. 14 illustrating an internally threaded pivot bearing.

FIG. 16 is a bottom plan view of the static bearing of FIG. 12 showing one possible arrangement of the threaded bores extending into the bottom surface.

### DETAILED DESCRIPTION

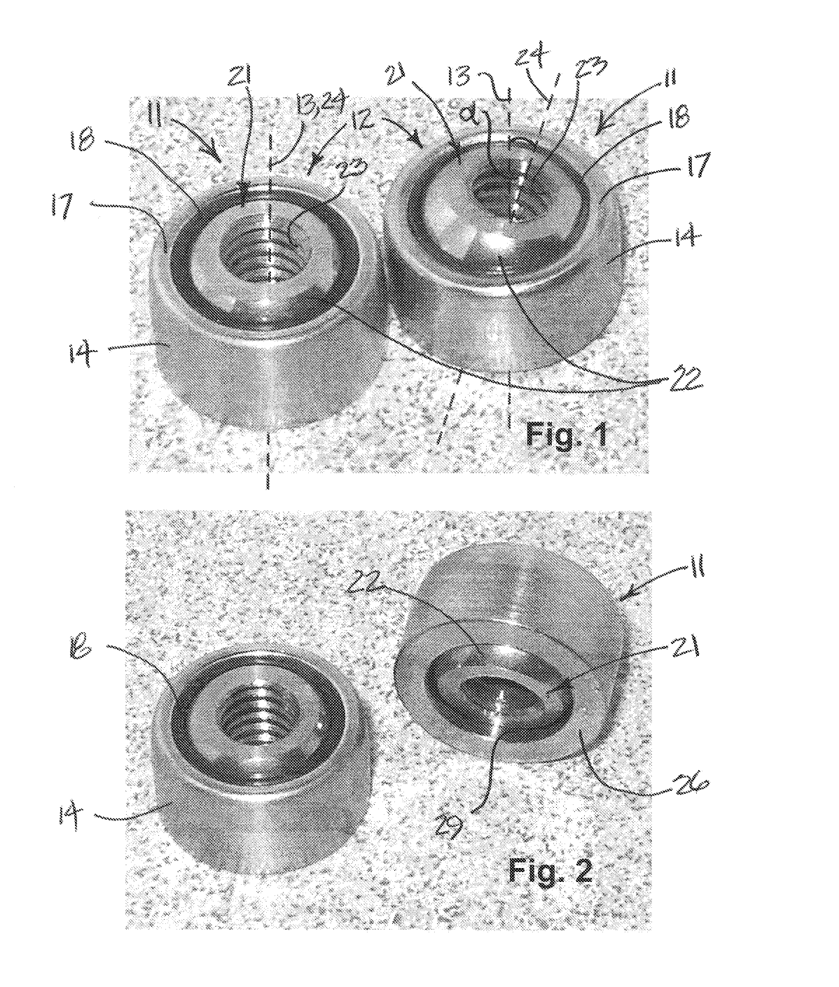

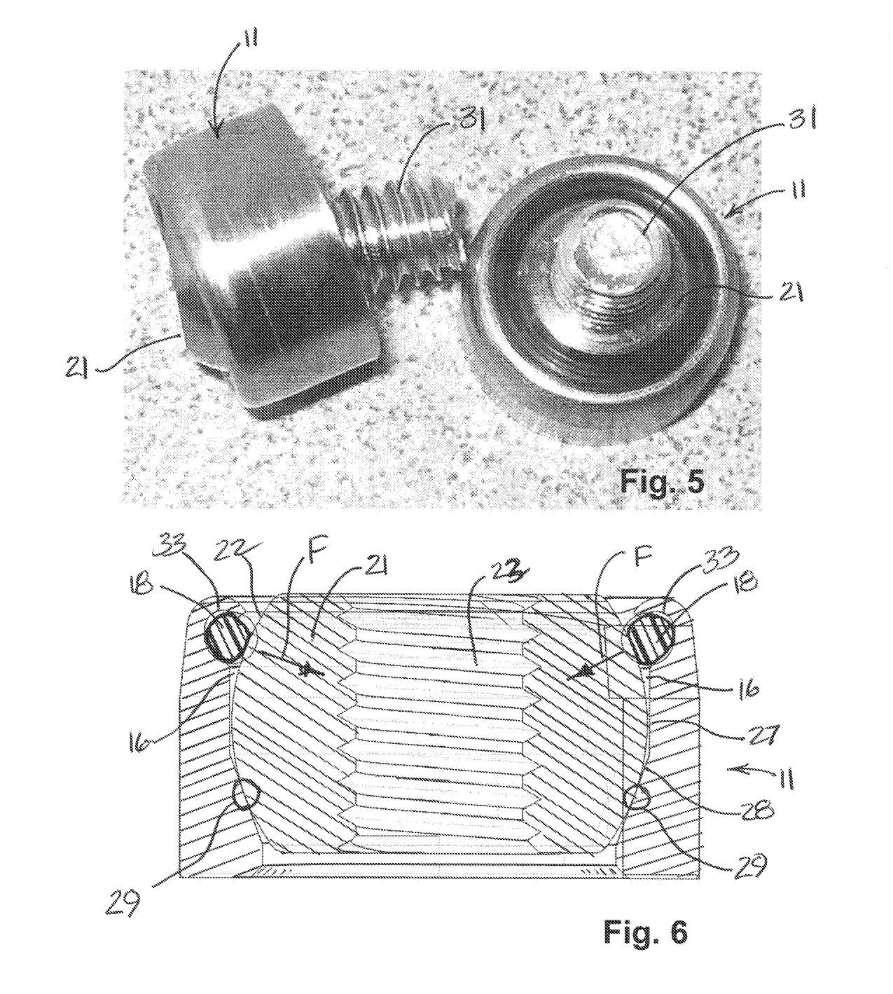

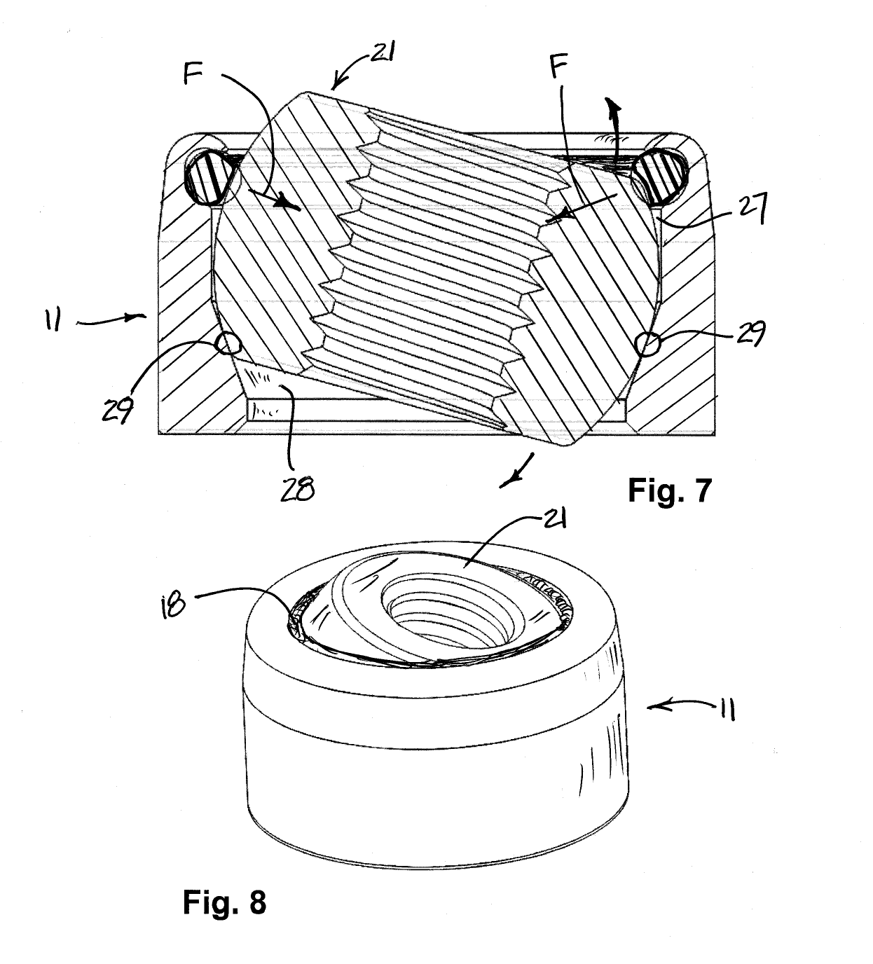

Reference will now be made in more detail to the drawing figures wherein like reference numerals indicate like parts throughout the several views. Referring first to FIGS. 1, 2, and 3 as a group, a static bearing assembly 11 according to one embodiment of the invention comprises a generally annular outer retainer 12 having an axis 13. The retainer has an outer wall 14, which may be shaped for press fit installation in an opening, and an inner wall 16 (shown in FIG. 6). The inner wall 16 has a first or upper conically shaped surface 27 that extends at a first angle with respect to the axis 13 and a second or lower conically shaped surface 27 that extends at a more acute angle with respect to the axis 13. The second or lower conically shaped surface defines a bearing seat 29, which is described in more detail below.

Referring again to FIGS. 1-3, the bearing assembly 11 further comprises a pivot bearing 21 disposed within the retainer 12. The pivot bearing 21 is formed with a generally spheroidal outer surface 22 and has a central bore 23 that, in this embodiment, is threaded. An elastomeric compression ring 18 is secured within a retaining groove on the inside surface of the retainer 12 and extends radially inwardly toward the outer surface 22 of the pivot bearing 21. The compression ring 18 bears against the outer surface 22 of the pivot bearing 21 with a predetermined force, which holds the outer surface 22 firmly against the bearing seat 29. The compression ring 18 is made of a material that establishes a predetermined friction or resistance to movement of the pivot bearing. The resistance to movement is determined by the ultimate intended use of the bearing assembly, but generally is sufficient to resist movement when an object attached to the pivot bearing but to allow the object to be manually re-oriented without manipulation of a locking device.

Referring to the cross sectional view of FIG. 6, the angles of the inner surface of the retainer 12 are selected so that the spheroidal outer surface of the pivot bearing 21 rests movably against the second or lower conically shaped surface or bearing seat as indicated at 29 in FIG. 6. It will thus be seen that the pivot bearing 21 can be pivoted through a predetermined range of angles within the retainer as the outer spheroidal surface of the pivot bearing moves on the bearing seat 29 defined by the lower conically shaped surface of the retainer.

With continued reference to FIG. 6, the elastomeric compression ring 18 is seen captured within an interior annular groove 33 formed just below the upper lip of the retainer 12. The compression ring 18 extends radially inwardly and is sized to engage and compress against and/or apply a force to the spheroidal outer surface of the pivot bearing 21. This imparts a force F to the pivot bearing 21 that generally is oriented inwardly and downwardly toward the bearing seat 29. Thus, the ease with which the pivot bearing 21 can pivot and rotate on the bearing seat can be increased or decreased as needed by changing the size, shape, and material of the elastomeric compression ring 18. The greater the force F imparted to the pivot bearing by the compression ring, the stiffer and less easily moved is the pivot bearing 21. In this way, the static pivot bearing assembly of this disclosure can be customized in stiffness and ease of movement for a particular end use or application.

FIGS. 1-3 illustrate the pivoting motion of the pivot bearing 21 within the retainer 12 through a predetermined angle. The bearing assembly 11 on the left in these figures is shown with the axis 24 of the pivot bearing 21 aligned with the axis 13 of the retainer 12. In other words, the pivot bearing is pivoted here through an angle of zero degrees with respect to the retainer. The bearing assembly 11 on the right in the figures shows the pivot bearing 21 pivoted within the retainer such that its axis 24 forms an angle α with respect to the axis 13 of the retainer. In addition to being pivoted within the retainer, the pivot bearing 21 also may be rotated within the retainer such that a full range of motion of the pivot bearing (and an object attached thereto) is possible within the angular range 2α.

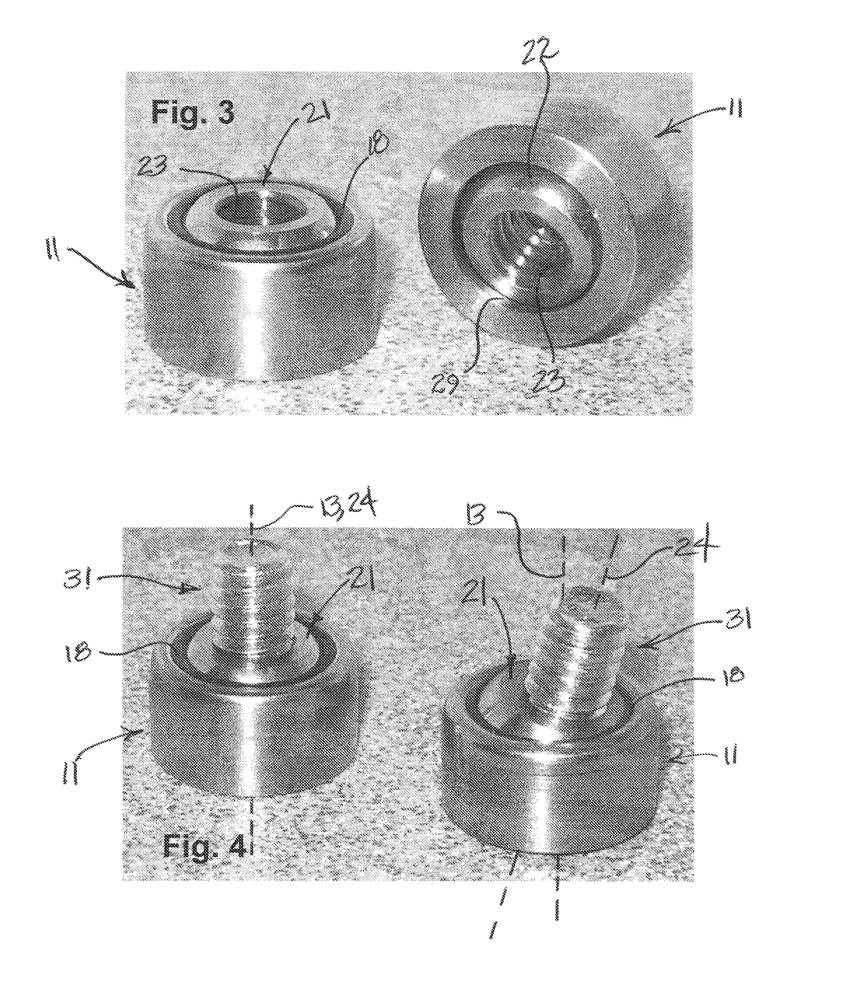

FIG. 2 shows the static bearing assembly 11 in both a normal and a pivoted configuration as seen from the upper or top portion of the assembly. FIG. 2 is the same as FIG. 1, except that the image of the pivoted bearing assembly (on the right) is seen from the bottom to reveal the bearing seat 29 on which the outer surface of the pivot bearing 21 rides. FIG. 3 is the same as FIG. 1 except that the image of the pivoted bearing assembly (on the right) shows the assembly on its side to reveal better the spheroidal outer surface of the pivot bearing 21.

FIGS. 4 and 5 are similar to FIGS. 1 and 2 except that here a threaded mounting stud is shown threaded into and extending from the threaded bore of the pivot bearing. The threaded stud is sized to accommodate an object to be attached to and supported by the pivot bearing of the bearing assembly. For example, the threaded stud may be the standard size and thread count of a camera mount and would allow a still or video camera to be mounted to the bearing assembly by being threaded onto the stud. Once attached, and with the compression ring being appropriately chosen, the camera is supported by the bearing assembly in its initial position by the resistance to movement of the pivot bearing provided by the compression ring. However, when there is a need to move the camera to another orientation, it need only be grasped, pivoted, and rotated until it assumes the new orientation. When the re-oriented camera is released, the bearing assembly again holds the camera in the new orientation until it is moved again. It will thus be seen that the camera (or any object attached to the assembly) can be re-oriented as much as is needed and is held in each orientation without the use of a separate locking screw or other mechanism to lock it in place.

FIGS. 6, 7, and 8 illustrate a preferred construction and operation of the bearing assembly 11 in cross section. FIG. 6 has been discussed above and illustrates perhaps more clearly how the compression ring 18 applies a force F to the pivot bearing. The force F tends to press the spheroidal outer surface of the pivot bearing against the bearing seat 29 with a pressure determined by the size, shape, and composition of the compression ring. FIG. 7 illustrates how this force is maintained substantially constant in magnitude and direction as the pivot bearing is pivoted and rotated within the retainer. Thus, movement of the pivot bearing is smooth and substantially constant throughout its range. FIG. 8 is a perspective view of the pivoted bearing assembly of FIG. 7 as seen from the top end or the end that carries the compression ring 18.

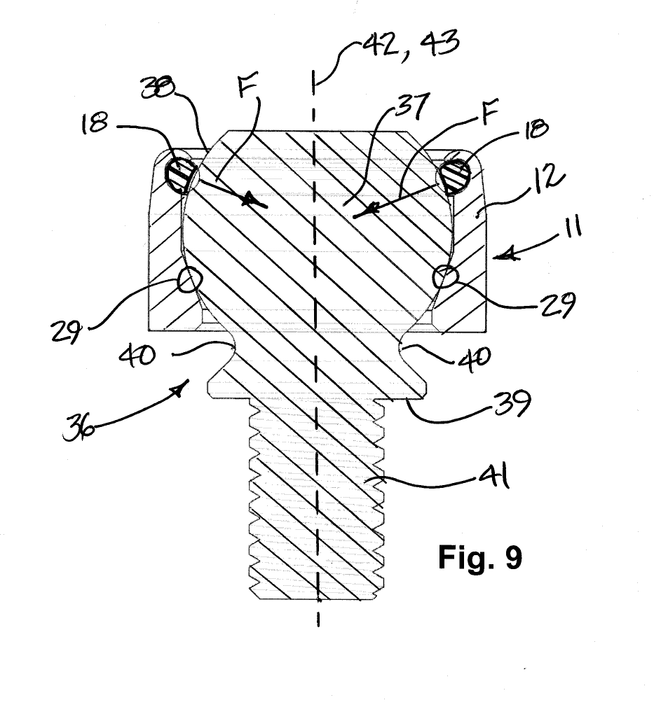

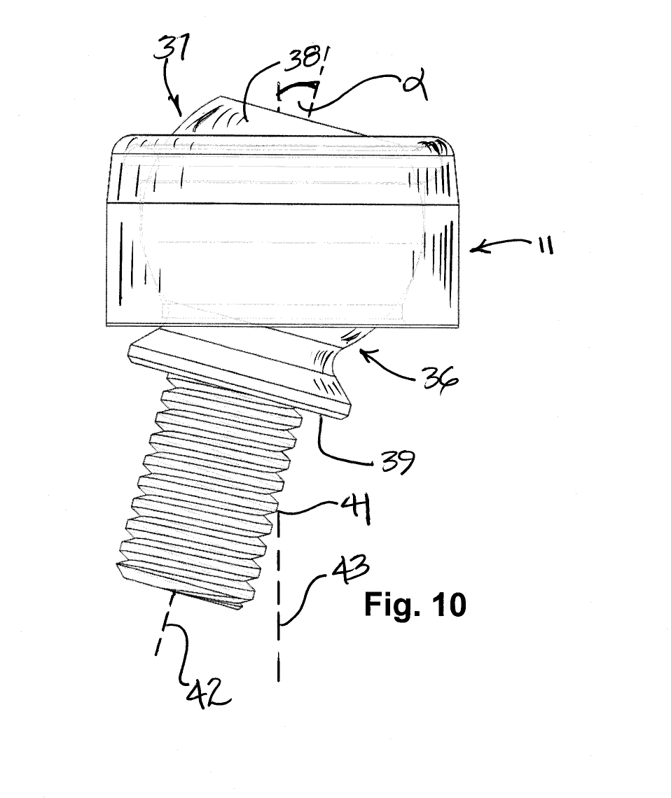

FIGS. 9 and 10 illustrate an alternate embodiment of the bearing assembly of the present disclosure wherein the mounting stud and the pivot bearing are constructed as a single monolithic component. As shown in FIG. 9, the bearing assembly 11 comprises a retainer 12 having an outer surface and a dual conically angled inner surface that defines a bearing seat 29. A pivoting attachment 36 has a pivot bearing portion 37 and an attachment portion, in this case a threaded stud 41. A flange 39 is formed at the base of the threaded stud and provides a stop against which an object threaded onto the stud is anchored. The pivot bearing portion 37 has a spheroidal outer surface that is disposed within the retainer 12 and rests against the bearing seat 29 therein. Elastomeric compression ring 18 applies a force F from the upper rim of the retainer toward the bearing seat to set the ease with which the pivoting attachment can be pivoted and rotated within the retainer.

In this particular embodiment, the threaded stud extends away from the lower or bottom surface of the bearing assembly and shoulders 40 provide a greater range of pivotal motion of the pivot bearing portion 37. In addition, the upper end of the pivot bearing portion projects further away from the upper rim of the retainer than does the pivot bearings in previous embodiments. This combination of features increases the range of pivotal motion significantly so that objects attached to the attachment portion 41 can be moved through greater ranges of motion. Other variations of this configuration clearly are possible within the scope of the invention. FIG. 10 shows the embodiment of FIG. 9 in a side plan view and illustrates how the pivoting attachment, and an object attached thereto, can pivot through an angle α and stay put once pivoted.

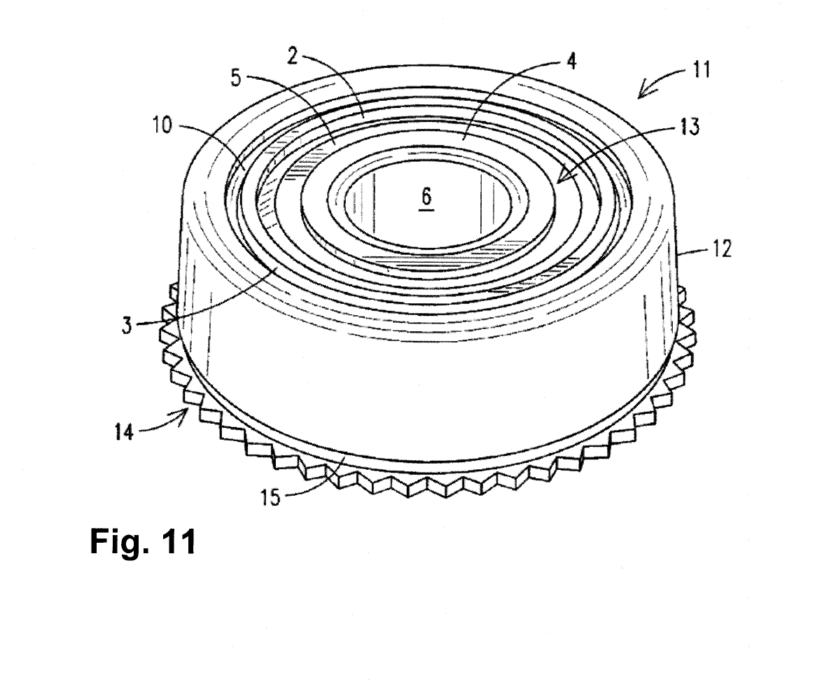

FIG. 11 is taken from one of our prior U.S. patents incorporated above. It is included here to illustrate press fit and self-clinching features 114 and 115 that also can be incorporated into the static bearing according to one embodiment. These features and their function are described in detail in the incorporated patents and those detailed descriptions are reincorporated here in their entireties. In general, features 114 and 115 provide the functions of press fit, wherein the bearing assembly can be pressed into an opening and lock there, and self-clinching, wherein the bearing clinches tightly within the opening when pressed into the opening.

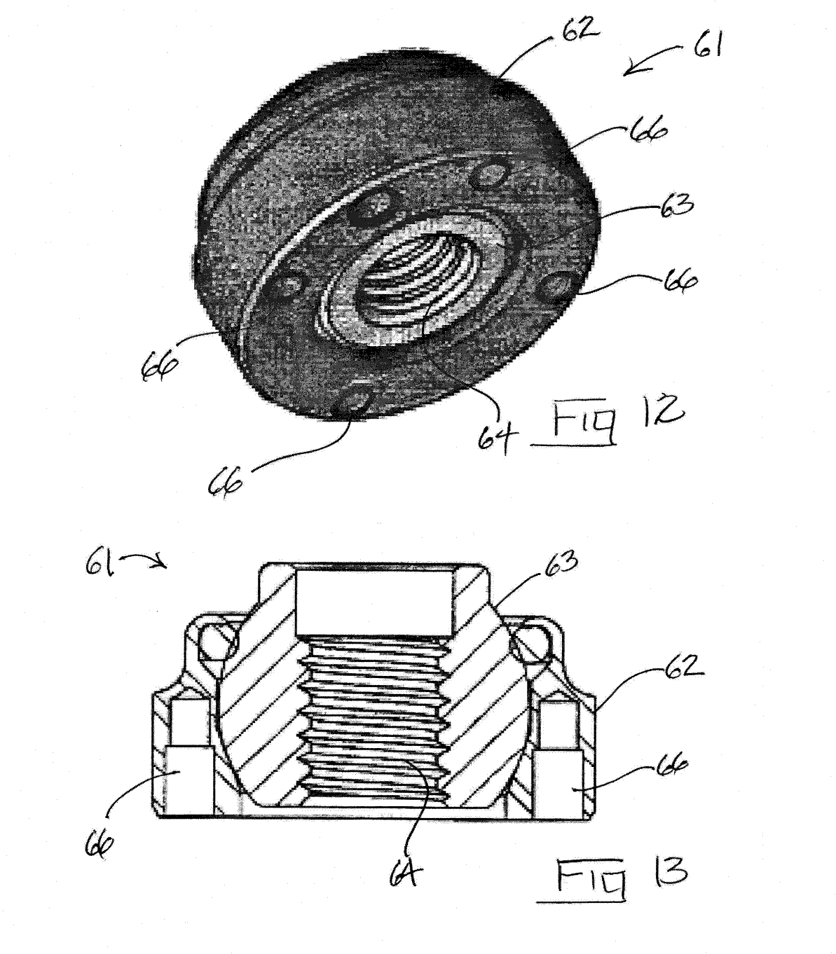

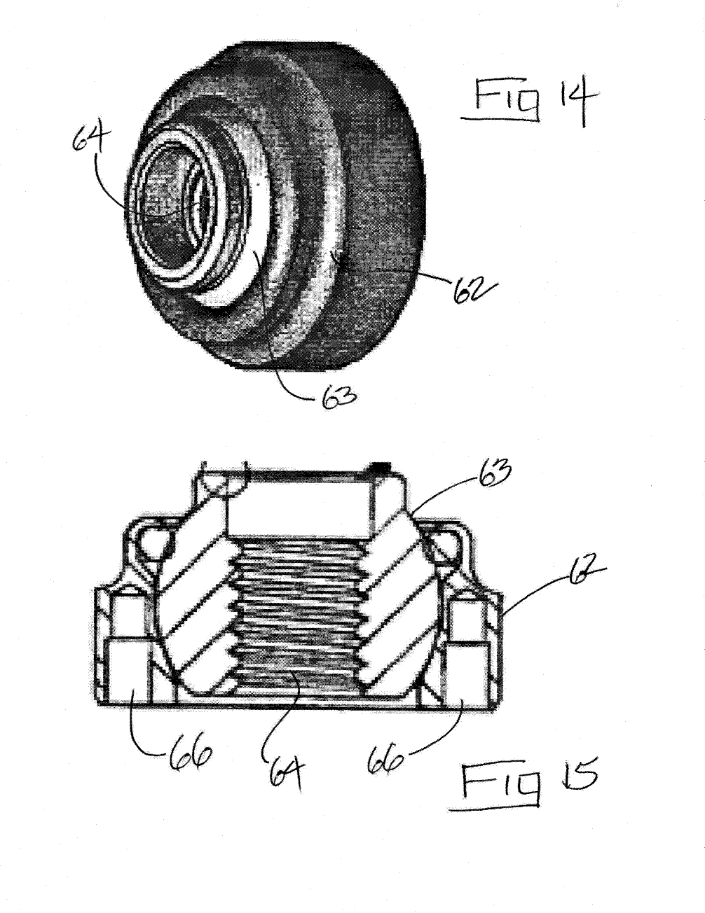

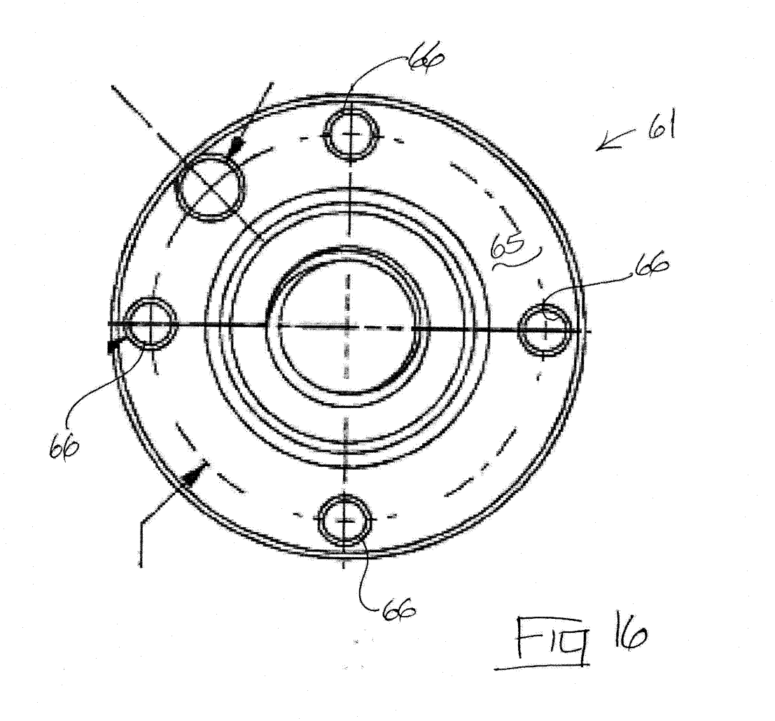

FIGS. 12-16 illustrate a slightly modified embodiment of the static bearing of the present disclosure. In this embodiment, a pivot bearing 63 is mounted for swiveling movement within a retainer 62 as described in detail above. The pivot bearing 63 is provided with internal threads 64 for receiving the mounting screw of an auxiliary object such as a camera. In this embodiment, the retainer 62 has an annular disc shaped bottom surface 65 (FIG. 6) through which a plurality of bores 66 is formed. The bores 66 may be internally threaded or may be configured for a snap fit by receiving prongs projecting upwardly from a mounting surface. In the illustrated embodiment, the bores 66 comprise four bores equally spaced around the bottom surface 65 as shown in FIG. 16. While this is considered the best mode of carrying out this embodiment of the invention, more or fewer than four bores may be provided depending upon application specific needs. In use, the static bearing of the embodiment of FIGS. 12-16 can be mounted to a support structure by screws threaded into bores 66 or by pressing the bearing onto snap-fit structures on the support. An ancillary device such as a camera mount can then be secured to the bearing by threading the mounting bolt of the camera mount into the threaded interior opening of the swivel ball 63. The camera or other object can then be positioned in a desired orientation simply by moving the object to the desired orientation as described in detail above. No locking mechanism is required as the static bearing holds the device in the orientation into which it is moved.

The invention has been described herein in terms of preferred embodiments and methodologies considered by the inventors to represent the best mode of carrying out the invention. It will be understood that a wide range of additions, deletions, and modifications both subtle and gross might well be made to the exemplary embodiments detailed herein by the skilled artisan without departing from the spirit and scope of the invention, which is circumscribed only by the claims hereof.

What is claimed is:

1. A static bearing assembly comprising:
a generally annular retainer having a central axis, an outer wall, and a generally conical inside wall that defines a bearing seat;
a pivot bearing mounted within the retainer; and
an elastomeric compression ring mounted within the retainer; wherein
the pivot bearing has a generally spheroidal outside wall that contacts the bearing seat and includes a mounting structure; and
the elastomeric compression ring is on a first end of the retainer, extends inwardly toward the central axis, and bears against the generally spheroidal outside wall of the pivot bearing.

2. The assembly of claim 1, wherein
the generally spheroidal outside wall has a diameter between a smallest diameter and a largest diameter of the generally conical inside wall of the annular retainer.

3. The assembly of claim 1, wherein
the elastomeric compression ring is positioned and sized to apply a predetermined force to the pivot bearing for holding the pivot bearing firmly between the bearing seat and the compression ring while allowing pivotal and rotational movement of the pivot bearing when a sufficient pivoting force is applied.

4. The assembly of claim 1, wherein
the elastomeric compression ring is secured within a retaining groove on the inside wall of the retainer.

5. The assembly of claim 1, wherein
the size, shape, or material of the elastomeric compression ring is preselected for adjusting the friction between the compression ring and the pivot bearing and thus the ease of movement of the pivot bearing.

6. The assembly of claim 1, wherein
the mounting structure includes a threaded opening, a projecting threaded stud, or both.

7. The assembly of claim 6, wherein
the projecting threaded stud has a first end threaded into the threaded opening, and a threaded, projecting, free second end.

8. The assembly of claim 1, wherein
the pivot bearing comprises a projecting threaded stud and the pivot bearing and projecting threaded stud are constructed as a single monolithic component.

9. The assembly of claim 8, wherein
the pivot bearing further includes shoulders for providing a greater range of motion.

10. The assembly of claim 8, wherein
the pivot bearing further includes a flange formed at a base of the projecting, threaded stud.

11. The assembly of claim 1, wherein
the pivot bearing includes press-fit or self-clinching features for mounting to a supporting structure.

12. The assembly of claim 1, wherein
the conical inside wall has a first surface extending at a first angle with respect to the central axis and a second surface extending at a second angle with respect to the central axis.

13. The assembly of claim 12, wherein
the second angle is more acute than the first angle and defines the bearing seat.

14. The assembly of claim 12, wherein
the first and second angle are selected such that the spheroidal outer surface of the pivot bearing contacts the bearing seat.

15. A static bearing assembly comprising:
a generally annular retainer having a central axis, an outer wall, a generally concave inside wall, and an annular bottom surface;
a pivot bearing mounted within the retainer; and
an elastomeric compression ring mounted within the retainer; wherein
the pivot bearing includes a central threaded opening for securing a device to the assembly and has a generally spheroidal outside wall that contacts the concave inside wall of the retainer;
the elastomeric compression ring is on a first end of the retainer, extends inwardly toward the central axis, and bears against the generally spheroidal outside wall of the pivot bearing; and
the annular bottom surface includes one or more bores for attaching the assembly to a support structure.

16. The assembly of claim 15, wherein
the one or more bores comprises four bores that are equally spaced around the annular bottom surface.

17. The assembly of claim 15, wherein
the bores include snap-fit structures or are threaded.

18. A method of mounting and orienting an object comprising:
obtaining a static bearing assembly having:
a generally annular retainer having a central axis, an outer wall, and a generally conical inside wall that defines a bearing seat,
a pivot bearing mounted within the retainer, the pivot bearing including a mounting structure and having a generally spheroidal outside wall that contacts the bearing seat and, and
an elastomeric compression ring mounted within the retainer, the elastomeric compression ring being on a first end of the retainer, extending inwardly toward the central axis, and bearing against the generally spheroidal outside wall of the pivot bearing;
mounting the object to the mounting structure;
orienting the object to a desired orientation by an application of a positioning force; and
after the application of the positioning force, passively maintaining the orientation of the object by the elastomeric compression ring bearing against the outside wall of the pivot bearing.

19. A method of mounting and orienting an object comprising:
obtaining a static bearing assembly having:
a generally annular retainer having a central axis, an outer wall, a generally concave inside wall, and an annular bottom surface, the annular bottom surface including one or more bores for attaching the assembly to a mounting surface;
a swivel ball mounted within the retainer, the swivel ball including a central threaded opening and having a generally spheroidal outside wall that contacts the concave inside wall of the retainer; and
an elastomeric compression ring mounted within the retainer, the compression ring extending inwardly toward the central axis, and bearing against the generally spheroidal outside wall of the swivel ball;
mounting the object to the central threaded opening;
orienting the object to a desired orientation by an application of a positioning force; and
after the application of the positioning force, passively maintaining the orientation of the object by the elastomeric compression ring bearing against the outside wall of the swivel ball.

20. The method of claim 19, wherein
the one or more bores for attaching the assembly to a mounting surface are threaded, and
the method further comprises mounting the static bearing assembly to a support structure having screws by threading the screws into the one or more bores.

21. The method of claim 19, further comprising
mounting the static bearing assembly to a support structure having snap-fit structures by pressing the bearing assembly onto the snap-fit structures of the support and mating the snap-fit structures with the one or more bores of the annular bottom surface of the retainer.
